(19) United States
(12) Patent Application Publication
(10) Pub. No.: US 2015/0292941 A1
(43) Pub. Date: Oct. 15, 2015

(54) MODAL DECOMPOSITION OF A LASER BEAM

(71) Applicant: CSIR, Pretoria (ZA)

(72) Inventors: Andrew Forbes, Irene (ZA); Christian Schulze, Jena (DE); Michael Rudolf Duparré, Jena (DE); Sandile Ngcobo, Pretoria (ZA)

(21) Appl. No.: 14/437,794

(22) PCT Filed: Oct. 24, 2013
(86) PCT No.: PCT/IB2013/059611

§ 371 Date: Apr. 22, 2015

(30) Foreign Application Priority Data
Oct. 24, 2012 (ZA) 2012/08029

(51) Int. Cl. G01J 1/42; G01J 9/00; H01S 3/00; G01J 1/04

(52) U.S. Cl. CPC G01J 1/4257; G01J 1/0437; G01J 1/0411; G01J 9/00; H01S 3/0014

(57) ABSTRACT

A method and apparatus for performing a modal decomposition of a laser beam are disclosed. The method includes the steps of performing a measurement to determine the second moment beam size (w) and beam propagation factor (M2) of the laser beam, and inferring the scale factor (wO) of the optimal basis set of the laser beam from the second moment beam size and the beam propagation factor, from the relationship: wO=w/M2. An optimal decomposition is performing using the scale factor wO to obtain an optimal mode set of adapted size. The apparatus includes a spatial light modulator arranged for complex amplitude modulation of an incident laser beam, and imaging means arranged to direct the incident laser beam onto the spatial light modulator. Fourier transforming lens is arranged to receive a laser beam reflected from the spatial light modulator. A detector is placed a distance of one focal length away from the Fourier transforming lens for monitoring a diffraction pattern of the laser beam reflected from the spatial light modulator and passing through the Fourier transforming lens. The apparatus performs an optical Fourier transform on the laser beam reflected from the spatial light modulator and determines the phases of unknown modes of the laser beam, to perform a modal decomposition of the laser beam.

### BACKGROUND TO THE INVENTION

This invention relates to a method of performing a modal decomposition of a laser beam, and to apparatus for performing the method.

The decomposition of an unknown light field into a superposition of orthonormal basis functions, so-called modes, has been known for a long time and has found various applications, most notably in pattern recognition and related fields [Reference 1], and is referred to as modal decomposition. There are clear advantages in executing such modal decomposition of superpositions (multimode) of laser beams, and several attempts have been made with varying degrees of success [References 2-6].

To be specific, if the underlying modes that make up an optical field are known (together with their relative phases and amplitudes), then all the physical quantities associated with the field may be inferred, e.g., intensity, phase, wavefront, beam quality factor, Poynting vector and orbital angular momentum density. Despite the appropriateness of the techniques, the experiments to date are nevertheless rather complex or customised to analyse a very specific mode set. Recently this subject has been revisited by employing computer-generated holograms for the modal decomposition of emerging laser beams from fibres [References 7-9], for the real-time measurement of the beam quality factor of a laser beam [References 10, 11], for the determination of the orbital angular momentum density of light [Reference 12, 13] and for measuring the wavefront and phase of light [Reference 14].

All these techniques rely on knowledge of the scale parameter(s) within the basis functions chosen. For example, in the case of free space modes the beam width of the fundamental Gaussian mode is the scale parameter (see later). There exists a particular basis without any scale parameters, the angular harmonics, but as this is a one dimensional (azimuthal angle) basis, it requires a scan over the second dimension (radial coordinate) to extract the core information [Reference 15]. In short, all the existing modal decomposition techniques have relied on a priori information on the modal basis to be used, and the scale parameters of this basis. Clearly this is a serious disadvantage if the tool is to be used as a diagnostic for arbitrary laser sources.

Presently there is no method available to do an optimal modal decomposition without some knowledge of the scale of the beam being studied.

It is an object of the invention to provide a method of performing an optimal modal decomposition without any prior knowledge of the scale parameters of the basis functions, thus enabling full characterisation of an unknown laser beam in real time.

### SUMMARY OF THE INVENTION

According to the invention there is provided a method of performing a scale invariant modal decomposition of a laser beam, the method including the steps of:
(a) performing a measurement to determine the second moment beam size (w) and beam propagation factor (M²) of the laser beam;
(b) inferring the scale factor (w₀) of the optimal basis set of the laser beam from the second moment beam size and the beam propagation factor, from the relationship: w₀=w/M; and
(c) performing an optimal decomposition using the scale factor w₀,

thereby to obtain an optimal mode set of adapted size.

The above steps allow the “actual” modes constituting the field to be deduced.

Step (a) of the method may be performed using an ISO-compliant method as described in References [16, 17] for measuring beam size and propagation factor, or with a full modal decomposition into a non-optimal basis set from which the unknown parameters may be inferred.

Preferably, however, step (a) is performed digitally, using a variable digital lens or virtual propagation using the angular spectrum of light.

In that case, where the beam propagation factor M² is measured digitally, the entire method can be performed by creating one or more variable lenses in the form of digital holograms and monitoring the resulting beam's properties.

As digital holograms are easy to create and may be refreshed at high rates, the entire procedure can be made all-digital and effectively real-time.

Step (c) may be performed using any modal decomposition method that makes use of a match filter and an inner product measurement.

Alternatively, step (c) may be performed by a modal decomposition into any basis.

Preferably, step (c) is performed using digital holograms to implement the match filter, thus making the measurement fast, flexible, programmable and real-time.

Further according to the invention there is provided apparatus for performing a modal decomposition of a laser beam, the apparatus including:
a spatial light modulator arranged for complex amplitude modulation of an incident laser beam;
imaging means arranged to direct the incident laser beam onto the spatial light modulator;
a Fourier transforming lens arranged to receive a laser beam reflected from the spatial light modulator; and
a detector placed a distance of one focal length away from the Fourier transforming lens for monitoring a diffraction pattern of the laser beam reflected from the spatial light modulator and passing through the Fourier transforming lens,
   thereby to perform an optical Fourier transform on the laser beam reflected from the spatial light modulator and to determine the phases of unknown modes of the laser beam, to perform a modal decomposition of the laser beam.

The spatial light modulator is preferably programmable to produce an amplitude and phase modulation of the incident laser beam.

In particular, the spatial light modulator may be programmable such that an output field thereof is the product of the incoming field and the complex conjugate of a mode within an orthonormal basis.

In a preferred example embodiment the spatial light modulator is operable to display a digital hologram.

The spatial light modulator is preferably operable to display the hologram as a grey-scale image wherein the shade of grey is proportional to the desired phase change.

### BRIEF DESCRIPTION OF THE DRAWINGS

FIGS. 1a and b are diagrams illustrating a simulation of the working principle of an optical inner product for detecting modal weights used in the method of the invention;

FIG. 2 is a simplified schematic diagram of core apparatus according to the invention for measuring properties of a laser beam for purposes of performing a modal decomposition thereof;

FIG. 3 is a schematic diagram of practical apparatus including the apparatus of FIG. 2;

FIGS. 4a to c are digital holograms for three sample laser beams using the method of the invention; and

FIGS. 5a to d are graphic representations of modal decomposition into adapted (a) and non-adapted basis sets (c to d) regarding scale.

### DESCRIPTION OF EMBODIMENTS

Optical fields can be described by a suitable mode set; the spatial structure of this mode set {ψₙ(r)} can be derived from the scalar Helmholtz equation. Any arbitrary propagating field U(r) can be expressed as a phase dependent superposition of a finite number of nₘₐₓ modes:

$$U ( r ) = {\sum }_{n = 1}^{{}^{n} max} {c}_{n} {ψ}_{n} ( r ) \qquad ( 1 )$$

where due to their orthonormal property

(ψₙ|ψₘ)=∫∫R²d²rψ*ₙ(r)ψₘ(r)=δₙₘ, (2)

the complex expansion coefficients cₙ may be uniquely determined from

cₙ=ρₙ exp(iΔφₙ)=(ψₙ|∪) (3)

and are normalized according to

$${\sum }_{n = 1}^{{}^{n} max} {\vert {c}^{n} \vert}^{2} = {\sum }_{n = 1}^{{}^{n} max} {ρ}_{n}^{2} = 1 \qquad ( 4 )$$

The benefit of this basis expansion of the field is that the required information to completely describe the optical field [Eq. (1)] is drastically reduced to merely nₘₐₓ complex numbers: this is sufficient to characterize every possible field in amplitude and phase. A further benefit is that the unknown parameters in Eq. (3), the modal weights (ρ²ₙ) and phases (Δφₙ) can be found experimentally with a simple optical set-up for an inner product measurement.

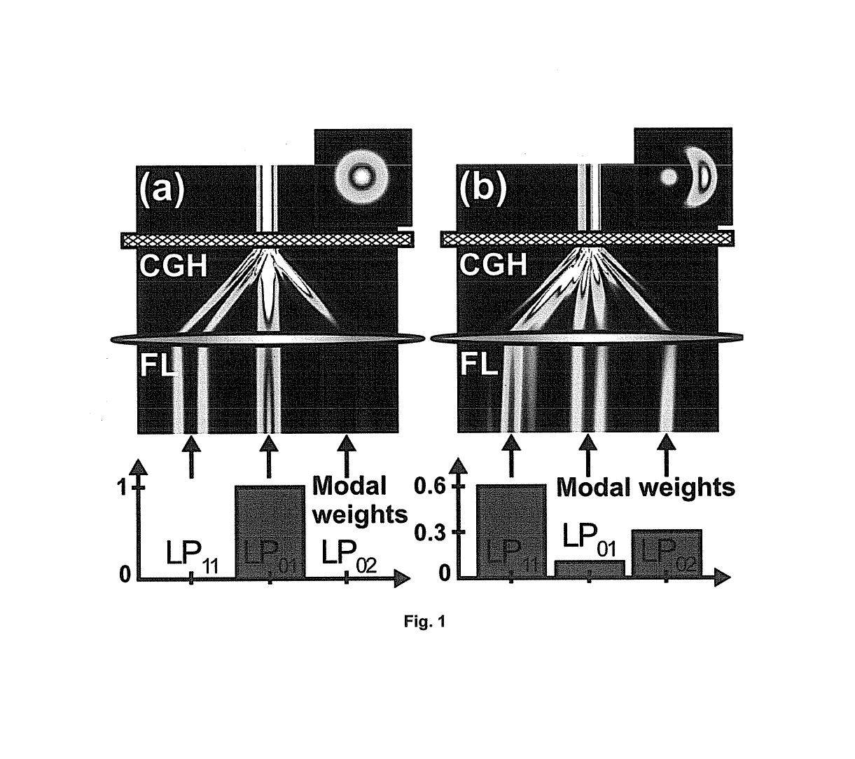

To illustrate the simplicity of the approach consider the scenario depicted in FIG. 1, where a single mode (a) and multimode beam (b) is to be analyzed, respectively; in our example the beam comprises some unknown weighting of modes. Now it is well known that if a match filter is set in the front focal plane of a lens, then in the far-field (back focal plane) the signal on the optical axis (at the origin of the detector plane) is proportional to the power guided by the respective mode. To be specific, if the match filter was set to be T(r)=ψ*ₙ(r), then the signal returned would be proportional to ρ²ₙ. To return all the modal weightings simultaneously, the linearity property of optics can be exploited: simply multiplex each required match filter (one for each mode to be detected) with a spatial carrier frequency (grating) to spatial separate the signals at the Fourier plane.

Returning to FIG. 1, we conceptually implement the match filter with a digital hologram or Computer Generated Hologram (CGH) and monitor the on-axis signal (pointed out by the arrows) in the Fourier plane of a lens. We illustrate that in the single mode case. FIG. 1 (a), only the on-axis intensity for the LP₀₁ mode is non-zero, while the other two have no signals due to the zero overlap with the incoming mode and the respective match filters. In FIG. 1 (b) the converse is shown, where all the modes have a non-zero weighting, and thus all the match filters have a non-zero overlap with the incoming mode. These intensity measurements return the desired coefficient, ρ²ₙ, for each mode. Unfortunately the modal weightings is necessary but not sufficient information to reconstruct the intensity of the (unknown) superposition beam [Eq. (1)], I(r)=|U(r)|², since it is dependent on the intermodal phase, Δφₙ. To illustrate this, consider the case of the coherent superposition of two modes, with a resulting interference pattern given by

I(r,Δφ)=A(r)+B(r) cos [Δφ+φ₀(r)] (5)

with the sum of the mode's intensities A(r)=Iₙ(r)+Iₘ(r), the interference term B(r)=2[Iₙ(r) Iₘ(r)]^{1/2}, the intermodal phase difference due to propagation delays Δφ=|βₙ−βₘ|z and the phase offset φ₀(r) caused by the spatial phase distribution of the interfering modes. The single intensities are given by the weighted squared absolute values of the respective mode fields Iₙ(r)=|ρₙψₙ(r)|².

FIG. 1 shows a simulation of the working principle of an optical inner product for detecting the modal weights of modes LP₁₁ₑ, LP₀₁ and LP₀₂ in the far-field diffraction pattern (from left to right). FIG. 1a relates to pure fundamental mode illumination. The intensity on the optical axes of the diffracted far-field signals (correlation answers) denoted by the upright arrows results in the stated modal power spectrum. FIG. 1b relates to the case where the illuminating beam is a mixture of three modes. According to the beam's composition, different intensities are detected on the corresponding correlation answers which result in the plotted modal power spectrum.

Laser beam quality is usually understood as the evaluation of the propagation characteristics of a beam. Because of its simplicity a very common and widespread parameter has become the laser beam propagation factor, M² value, which compares the beam parameter product (the product of waist radius and divergence half-angle) of the beam under test to that of a fundamental Gaussian beam [see Reference 18]. The definition of the beam propagation factor for simple and general astigmatic beams and its instruction for measurement can be found in the ISO standard [see References 16, 17]. Here, the measurement of the beam intensity with a camera in various planes is suggested, which allows the determination of the second order moments of the beam and hence the M² value.

Several techniques have been proposed to measure the M² value such as the knife-edge method or using a variable aperture [see References 19-21]. However, despite the fact that these methods might be simple, they do not lead to comparable results [see, in particular, Reference 19]. Moreover, the required scanning can be a tedious process if many data points are acquired. Another approach to measure the M² value uses a Shack-Hartmann wavefront sensor, but was shown to yield inaccurate results for multimode beams [see Reference 20].

ISO-compliant techniques include the measurement of the beam intensity at a fixed plane and behind several rotating lens combinations [Reference 20], multi-plane imaging using diffraction gratings [Reference 21] or multiple reflections from an etalon [Reference 22], direct determination of the beam moments by specifically designed transmission filters [Reference 23], and field reconstruction by modal decomposition [References 10, 11, 25].

In essence all approaches to measuring the beam quality factor require several measurements of either varying beam sizes and/or varying curvatures. This has traditionally been achieved by allowing a beam of a given size and curvature to propagate in free space, i.e., nature provides the variation in the beam parameters through diffraction. An obvious consequence of this is that the detector must move with the propagating field, the ubiquitous scan in the z direction. In this application it will be illustrated that it is possible to achieve the desired propagation with digital holograms: effectively free space propagation without the free space.

In this approach two methods of implementation are: (1) creating a digital lens, and (2) manipulating the angular spectrum of the beam to simulate virtual propagation. In both cases the intensity is measured with a camera in a fixed position behind an SLM (spatial light modulator) and no moving components are required. Both strategies enable accurate measurement of the beam quality. Importantly, the measurement is fast and easy to implement.

### Variable Digital Lenses

In the first method we implement the required changing beam curvature by programming a digital lens of variable focal length. In this case the curvature is changing in a fixed plane (that of the hologram), thus rather than probing one beam at several planes we are effectively probing several beams at one plane (each hologram can be associated with the creation of a new beam). This method, referred to below as Method A, is described on pages 1 and 2 of Annexure B.

### Virtual Propagation

The second approach manipulates the spatial frequency spectrum (angular spectrum) of the beam to simulate propagation. In this method, the input beam is Fourier transformed using a physical lens, then modified by a digital hologram for virtual propagation and then inverse Fourier transformed using a second lens. From a hyperbolic fit of these diameters, the M² value can be determined according to the ISO standard [see References 16, 17]. This method, referred to below as Method B, is described on page 2 of Annexure B.

In consequence, a casuistic measurement can be performed, but without any elaborate modal decomposition necessary and without any knowledge about the beam under test.

Note that both methods can be easily extended to handle general astigmatic beams by additionally displaying a cylindrical lens on the SLM.

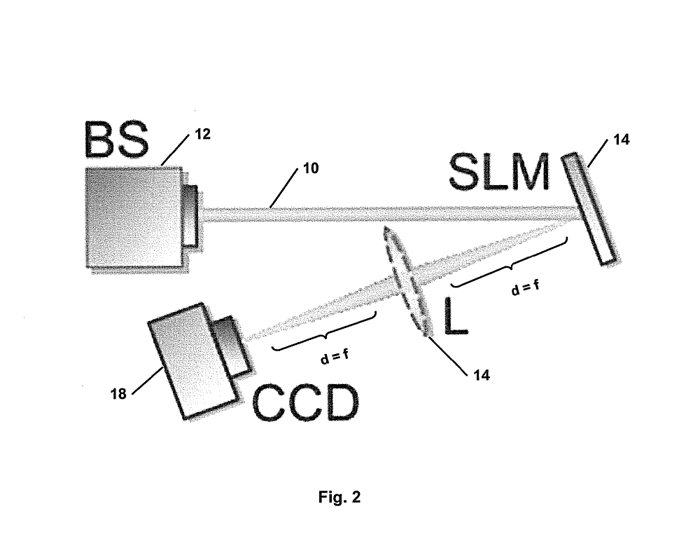

In brief, the method of the invention involves finding the scale of the unknown field, and then performing a modal decomposition of this field. The core apparatus needed for implementing these steps is shown in the simplified schematic diagram of FIG. 2.

In FIG. 2, a laser beam 10 output from a beam splitter 12 is aimed onto a spatial light modulator (SLM) 14. The beam 10 is reflected from the SLM 14 via an optical lens 16 to a detector 18. The SLM is operated to display a digital hologram. Typically the SLM would be a phase-only device, with commercially available from several suppliers (e.g., Holoeye or Hamamatsu). It should have a good resolution (better than 600×600 pixels) and a diffraction efficiency of >60%. The most important requirement is a maximum phase modulation at the design wavelength of >Pi radians.

The lens 18 is preferably a spherical lens of focal length f, placed a distance d=f after the SLM and a distance d=f in front of the detector. There are no special requirements on this component.

The detector 18 preferably takes the form of a CCD camera or a photo-diode placed at the centre of the optical axis. There are no special requirements on this component.

The method is implemented as follows:

Some incoming yet unknown field (laser beam 10) is directed with suitable optics to the SLM 14. The SLM is programmed to produce an amplitude and phase modulation of the incoming field such that the output field is the product of the incoming field and the complex conjugate of a mode within an orthonormal basis. The hologram is displayed as a grey-scale image where the “colour” (represented as a shade of grey) is proportional to the desired phase change.

At this point we have modified the input field to a new field, since the amplitude and phase is changed in a non-trivial manner across the beam. This new field has the characteristics of an inner product between the incoming field and the hologram displayed on the SLM. To actually realise the inner product, the new field is passed through a 2f system (a distance f, followed by a lens of focal length f, and then another distance f). This configuration represents an optical Fourier transform. At the origin of this plane (the Fourier plane) the signal measured will be proportional to the inner product of the unknown field and the hologram. The hologram is changed to cycle through the basis functions of the orthonormal set (the “modes”). The signal strength is a direct measure of how much of this mode is contained in the original field.

By changing the hologram to modulate the field by a sinusoidal function, the phases of the unknown modes can also be inferred. Depending on the basis functions used and the tools to do the complex amplitude modulation, the orthogonality of the basis should be checked and, if needed, the signal strengths may require some renormalization to correct the inner product amplitudes and phases. This procedure is repeated until the signals measured are zero, or close to zero. This can be defined as the point where the energy contained in the already measured modes exceeds 99%. For each mode within the basis, a hologram is required for the amplitude and the phase of the mode. This can be done in series, as separate holograms, or in parallel by using a grating with each hologram that deflects the signal to a new position on the CCD camera array. This represents the modal decomposition of light into a chosen basis of a given size.

To select the size is the purpose of the first step. The procedure outlined above can be used to extract the size, and then repeated in the basis with the new size. This would mean new holograms—the same pictures and functions except that the size of the hologram would be different. Exactly the same set-up is used when applying the digital approach to mimic a virtual propagation. A hologram is first displayed that modulates the angular spectrum of the light, or by using a digital lens—both are digital and both are very accurate. In both cases the beam size change at the plane of the CCD is measured and plotted as a function of the hologram parameters (e.g., digital focal length). From the fit, the unknown beam's size and beam propagation factor can be extracted.

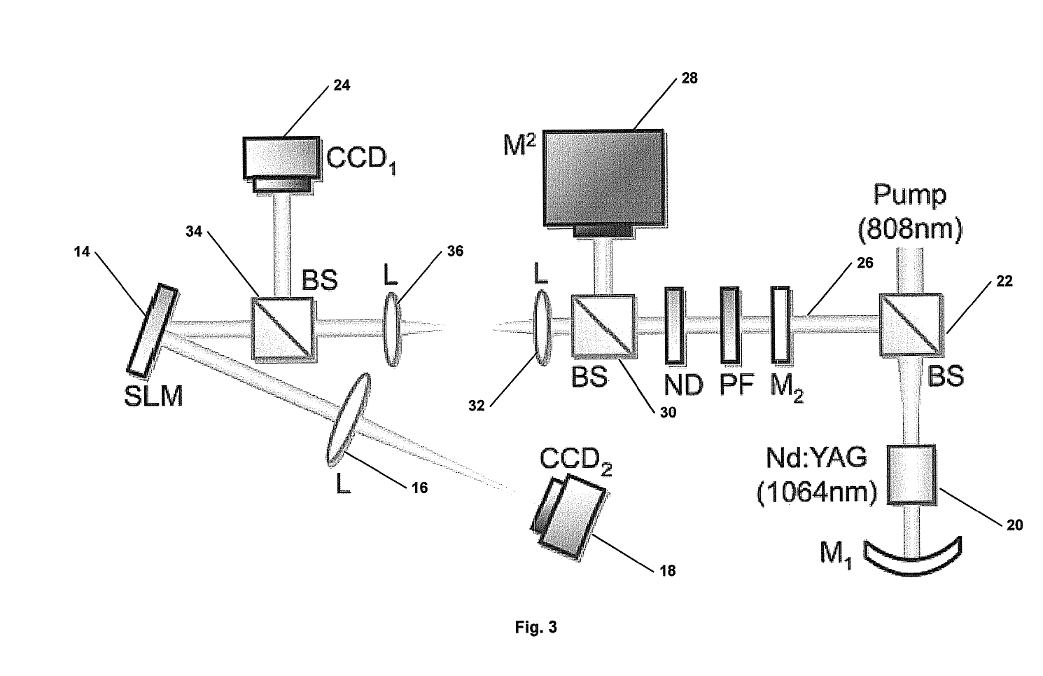

An exemplary embodiment of apparatus for generating a laser beam to be measured, and including the core apparatus of FIG. 2, is shown schematically in FIG. 3.

The apparatus includes an end-pumped Nd:YAG laser resonator 20 for creating the beams under study, having a stable plano-concave cavity with variable length adjustment (300-400 mm).

The back reflector of the laser resonator was chosen to be highly reflective with a curvature R of 500 mm, whereas the output coupler used was flat with a reflectivity of 98%. The gain medium, a Nd:YAG crystal rod (30 mm×4 mm), was end-pumped by a 75 W Jenoptik multimode fibre coupled laser diode (JOLD 75 CPXF 2P W). The resonator output at the plane of the output coupler 22 was relay imaged onto a CCD camera 24 (Spiricon LBA USB L130) to measure the size of the output beam 26 in the near field, and could be directed to a laser beam profiler device 28 (Photon ModeScan1780) for measurement of the beam quality factor. The same relay telescope (comprising a first beam splitter 30 with associated lens 32, and a second beam splitter 34 with associated lens 36) was used to image the beam from the output coupler to the plane of the spatial light modulator (SLM) 14 (Holoeye HEO 1080 P). The SLM 14, calibrated for 1064 nm wavelength, was used for complex amplitude modulation of the light prior to executing an inner product measurement [see Reference 12] with a Fourier transforming lens 16 (f=150 mm).

In order to select specific transverse modes, an adjustable intra-cavity mask was inserted near the flat output coupler 22. By adjusting the resonator length and the position of the mask, the laser could be forced to oscillate either on the first radial Laguerre Gaussian mode (LG_{0,1}), a coherent superposition of LG_{0,±4} beams (petal profile) or a mixture of the LG_{0,1} and LG_{0,±4} modes. The length adjustment, which alters the Gaussian mode size, can be viewed as a means to vary the scale parameter of the modes, while the mask position selects the type of modes to be generated.

### Examples and Permutations

The described technique requires the implementation of match filters for complex amplitude modulation of light. This allows for the creation of arbitrary basis functions used in the decomposition, which may require phase and amplitude modulation. It is desirable to make the match filters programmable and not “hard-wired” to a particular basis function and scale. For this a programmable amplitude and phase mask is required.

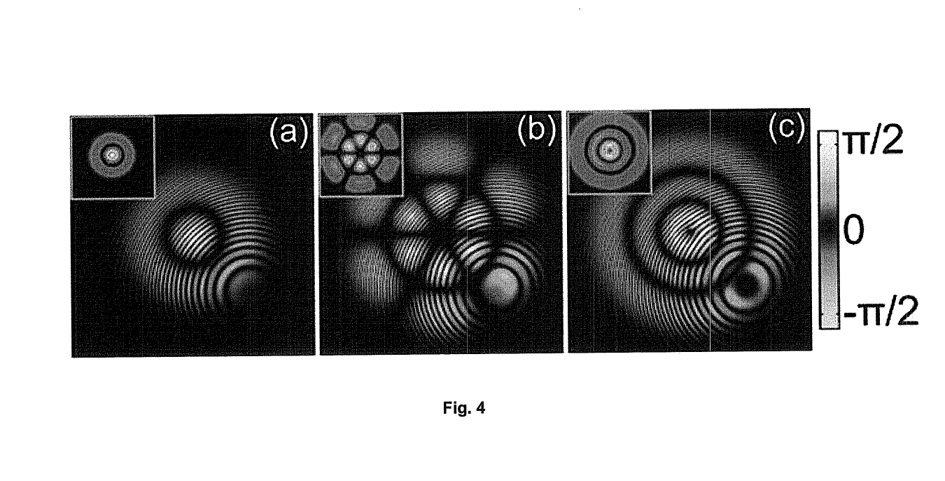

This programmable mask is implemented by digital holography, making use of colour encoded digital holograms to represent the match filters. Examples of such holograms are shown in FIGS. 4a to 4c, which are digital holograms for three sample beams using method A with a focal length of 400 mm.

In the prototype system, the holograms are written to a liquid crystal device in the form of a spatial light modulator, as described above, as it satisfies all the requirements of the task.

The described technique requires an inner product measurement, which can be realised with a conventional lens and a small detector at the origin of the focal plane. An example of such a setup is shown in FIG. 2.

In the prototype apparatus, a single pixel of a CCD device was used as a detector. The single pixel could be replaced with any equivalent detector, e.g. a photodiode or pin-hole and bucket detector system, or a single mode fibre as the entrance pupil for light collection. The source of light to be tested may be any coherent optical field. For example, the method has been tested using fibre sources, solid-state laser resonators and gas lasers.

Once the described method has been completed, the following information on the original field is available from the data: intensity, phase, wavefront, modal content, orbital angular momentum and Poynting vector.

If the method is combined with standard polarisation measurements, then the full Stokes parameters are available allowing vector light fields to be measured and characterised.

The first step of the two step process can be done digitally. In particular, it can be done by a technique of creating variable lenses in the form of digital holograms and monitoring the resulting beam's properties.

An example of this approach is given in FIG. 1 of Appendix B and the core calculation is based on Eq. 1 of Appendix B. with a typical measure result shown in FIG. 4(a) of Appendix B.

Alternatively, the first step can be done by a technique of simulating virtual propagation of light by modifying the angular spectrum of light.

An example of this approach is illustrated in FIG. 1 and the core calculation is based on Eq. 2 of Appendix B, with a typical measure result shown in FIG. 4(b) of Appendix B.

Both approaches have been tested on a variety of laser beams and shown to be very accurate, as shown in Table 1 of Appendix B.

A key feature of the described method is that it overcomes previous disadvantages of scale problems without any additional components, and without a major paradigm shift in how to understand decompositions of light, and does so in an all-digital approach. Particular advantages are that it requires only conventional optical elements, is robust against scale and can be performed in real-time with commercially available optics to read digital holograms.

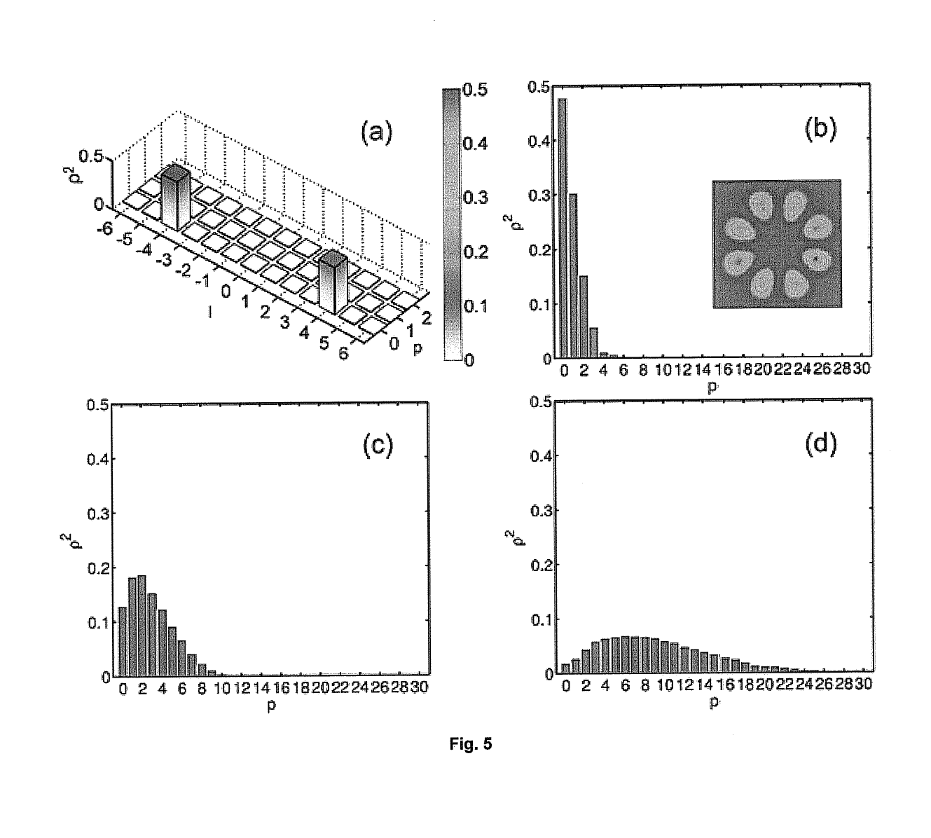

Another key feature of the described method is the small number of measurements of modes required for a complete modal decomposition. An example is shown in FIGS. 5a to d, which show modal decomposition into adapted and non-adapted basis sets regarding scale. FIG. 5a shows modal decomposition into LG_{p,±4} modes of adapted basis scale w₀. FIGS. 5b to d show decomposition into LG_{p, ±4} modes with scale 0.75w₀, 2w₀ and 3w₀, respectively. The inset in FIG. 5b depicts the measured beam intensity.

FIG. 5a shows only two modes in the original beam, whereas FIGS. 5b, c and d show ever increasing modes due to an incorrect scale of the decomposition.

The large mode numbers inherent in other techniques result in low signals and therefore difficult measurements, as indicated in FIG. 4, both of which are overcome by the described method.

This is seen by considering the amplitude of the detected signal, ρ²: when the measurement is done at the correct size (w/w₀=1) the signal is close to 1 (100%). As we deviate away from the correct size, so the signal decreases. For example, when w/w₀=0.5 the signal is 0.1, or 10% or the original value. This implies less signal-to-noise. The remaining signal is distributed across many other modes.

The described technique has been shown to be very accurate when measuring free-space laser beams as are typical from most laser systems, as shown in Table 1 and FIGS. 4 and 5 of Appendix A.

### REFERENCES AND LINKS

1. J. W. Goodman, Introduction to Fourier Optics (McGraw-Hill Publishing Company, 1968).
2. M. A Golub, A. M Prokhorov, I. N. Sisakian and V. A. Soifer “Synthesis of spatial filters for investigation of the transverse mode composition of coherent radiation,” Soviet Journal of Quantum Electronics 9, 1866-1868 (1982).
3. E. Tervonen, J. Turunen and A. Friberg, “Transverse laser mode structure determination from spatial coherence measurements: Experimental results,” Appl. Phys: B:Laser Opt 49. 409-414 (1989).
4. A. Cutolo, T. Isernia, I. Izzo, R. Pierri, and L. Zeni, “Transverse mode analysis of a laser beam by near and far-field intensity measurements,” Appl. Opt. 34 7974 (1995).
5. M. Santarsiero, F. Gori, R Borghi, and Guattari, “Evaluation of the modal structure of light beams composed of incoherent mixtures of hermite-gaussian modes,” Appl. Opt. 38 5272-5281 (1999).
6. X. Xue, H. Wei and A. G Kirk,” Intensity-based modal decomposition of optical beams in terms of hermite-gaussian functions,” J Opt Soc Am. A 17, 1086-1091 (2000).
7. D. Flamm, O. A Schmidt, C. Schulze, J. Borchardt, T. Kaiser, S. Schröter, and M Duparré, “Measuring the spatial polarization distribution of multimode beams emerging from passive step-index large mode-area fibers,” Opt. Lett. 35, 3429-3431 (2010).
8. T. Kaiser, D Flamm, S. Schröter, and M. Duparré, “Complete modal decomposition for optical fibers using CGH-based correlation filters, “Opt Express 17. 9347-9356 (2009)
9. D. Flamm, D. Naidoo, C. Schulze, A. Forbes, and M. Duparré, “Mode analysis with a spatial light modulator as correlation filter,” Opt. Lett. 37, 2478-2480 (2012).
10. D. Flamm, C. Schulze, R. Brüning, O. A Schmidt. T. Kaiser, S. Schoröter, and M. Duparré, “Fast M2 measurement for fiber beams based on modal analysis,” Appl. Opt. 51, 987-993 (2012).
11. O. A Schmidt, C. Schulze, D. Flamm, R. Brüning, T. Kaiser, S. Schröter, and M. Duparré, “Real-time determination of laser beam quality by modal decomposition,” Opt. Express 19, 6741-6748 (2011).
12. Litvin I., Dudley A., and Forbes A., “Poynting vector and orbital angular momentum density of superpositions of Bessel beams,” Optics Express 19(18), 16760-16771 (2011).
13. Dudley A., Litvin I., and Forbes A., “Quantitative measurement of the orbital angular momentum density of light,” Applied Optics 51(7), pp. 823-833 (2012).
14. Schultz C., Naidoo D., Flamm D., Schmidt O., Forbes A., and Duparre M., “Wavefront reconstruction by modal decomposition,” Optics Express 20(18), pp. 19714-19725 (2012).
15. Litvin I., Dudley A., Roux F. S., and Forbes A., “Azimuthal decomposition with digital holograms,” Optics Express 20(10), pp. 10996-11004 (2012).
16. ISO, “ISO 11146-1:2005 Test methods for laser beam widths, divergence angels, and beam propagation rations, Part 1: Stigmatic and simple astigmatic beams,” (2005).
17. ISO, “ISO 11146-2:2005 Test methods for laser beam widths, divergence angles and beam propagation ratios. Part 2: General astigmatic beams”, (2005).
18. B. Neubert, G. Huber, W.-D. Scharfe, “On the problem of M² analysis using Shack-Hartmann measurements, “J. Phys. D: Appl. 34, 2414 (2001)
19. A. E Siegman, “How to (maybe) measure laser beam quality,” in DPSS (Diode Pumped Solid State) Lasers Application an Issues,” (Optical Society of America. 1998), p. MQ1.
20. J. Strohaber, G kaya, N Kaya, N. Hart, A. A Kolomeskii, G. G Paulus, and H. A Schuessler, “In situ tomography of femtosecond optical beams with a holographic knife-edge,” Opt. Express 19, 14321-14334 (2011).
21. G. Nemes and A. E Siegman, “Measurement of all ten second order moments of an astigmatic beam by the use of rotating simple astigmatic (anamorphic) opticsa,” J. Opt. Soc. Am A 11, 2257-2264 (1994).
22. R. W. Lambert R Cortes-Martinez, A. J Waddie, J. D Shephard, M. R Taghizadeh, A. H Greenaway, and D. P Hand, “Compact Optical system for pulse to pulse laser beam quality measurement and applications in laser machining,” Appl. Opt. 43, 5037-5046 (2004).
23. M. Scaggs and G. Haas, Real time monitoring of thermal lensing of a multikilowatt fiber laser optical system,” Proc. SPIE, vol. 8236,8260H1 (2012).
24. A. Letsch, “Charakterisierung allgemein astimatischer laserstrahlung mit der Methode der zweiten Momente,” PhD thesis (2009)
25. P. Kwee, F. Seifert, B. Willke, and K. Danzmann, “Laser beam quality and pointing measurements with an optical resonator,” Rev. Sci. Instrum: 78, 073103-073103-10 (2007).

1-13. (canceled)

14. A method of performing a scale invariant modal decomposition of a laser beam, the method including the steps of:
performing a measurement to determine the second moment beam size (w) and beam propagation factor (M²) of the laser beam;
inferring the scale factor (w₀) of the optimal basis set of the laser beam from the second moment beam size and the beam propagation factor, from the relationship: w₀=w/M; and
performing an optimal decomposition using the scale factor w₀,
thereby to obtain an optimal mode set of adapted size.

15. The method of claim 14 wherein the step of performing a measurement is performed using an ISO-compliant method for measuring beam size and propagation factor.

16. The method of claim 14 wherein the step of performing a measurement is performed with a full modal decomposition into a non-optimal basis set from which the unknown parameters may be inferred.

17. The method of claim 14 wherein the step of performing a measurement is performed digitally, using a variable digital lens or virtual propagation using the angular spectrum of light.

18. The method of claim 17 wherein where the beam propagation factor M² is measured digitally by creating one or more variable lenses in the form of digital holograms and monitoring the resulting beam's properties.

19. The method of claim 14 wherein the step of performing an optimal decomposition is performed using a modal decomposition method that makes use of a match filter and an inner product measurement.

20. The method of claim 14 wherein the step of performing an optimal decomposition is performed by a modal decomposition into any basis.

21. The method of claim 14 wherein the step of performing an optimal decomposition is performed using digital holograms to implement the match filter.

22. Apparatus for performing a modal decomposition of a laser beam, the apparatus including:
a spatial light modulator arranged for complex amplitude modulation of an incident laser beam;
imaging means arranged to direct the incident laser beam onto the spatial light modulator;
a Fourier transforming lens arranged to receive a laser beam reflected from the spatial light modulator; and
a detector placed a distance of one focal length away from the Fourier transforming lens for monitoring a diffraction pattern of the laser beam reflected from the spatial light modulator and passing through the Fourier transforming lens,
thereby to perform an optical Fourier transform on the laser beam reflected from the spatial light modulator and to determine the phases of unknown modes of the laser beam, to perform a modal decomposition of the laser beam.

23. Apparatus according to claim 22 wherein the spatial light modulator is programmable to produce an amplitude and phase modulation of the incident laser beam.

24. Apparatus according to claim 23 wherein the spatial light modulator is programmable such that an output field thereof is the product of the incoming field and the complex conjugate of a mode within an orthonormal basis.

25. Apparatus according to claim 22 wherein the spatial light modulator is operable to display a digital hologram.

26. Apparatus according to claim 25 wherein the spatial light modulator is operable to display the hologram as a grey-scale image wherein the shade of grey is proportional to the desired phase change.
